(19) United States
(12) Patent Application Publication
(10) Pub. No.: US 2004/0009454 A1
(43) Pub. Date: Jan. 15, 2004

(54) Dental saw blade

(76) Inventor: Joseph Klipper, New York, NY (US)

Correspondence Address: DARBY & DARBY P.C., Post Office Box 5257, New York, NY, 10150-5257, US

(21) Appl. No.: 10/194,649

(22) Filed: Jul. 11, 2002

(51) Int. Cl. A61C 3/02

(52) U.S. Cl. 433/165

(57) ABSTRACT

A dental saw blade is provided and includes a body having a first face and an opposing second face and a cutting edge and a central opening for receiving a drive component for rotating the blade. The blade has a region of abrasive material disposed on each of the first and second faces to define a cutting zone at an outer section of the face and further has a means for stiffening the body and reducing binding of the blade during a cutting operation. The means is disposed between the cutting zone and the central opening and includes features that are formed on each of the first and second faces.

### TECHNICAL FIELD

The present invention relates generally to dental tools and more particularly, to a dental saw blade for use with a motorized dental saw and having a more robust construction that permits deeper cuts without warping and/or binding of the blade.

### BACKGROUND

Dental work often requires different types of workpieces be to fabricated and then cut to form by making intricate cuts in the material that forms the workpiece. For example, in dental work involving fixed crown and bridge work, a dental cast of the patient's dental features (i.e., the dental arch) is made and the teeth to which the crown or bridge work is to be fitted are then sectioned and sawed from the dental arch for easy work. It will be appreciated that dental casts are made for a number of different reasons and also other dental materials are used for other applications that require the operation of a dental saw to make some type of cut to tailor the shape of the dental material to fit a particular patient.

While hand-operated coping saws have been used to perform this particular task, there are several drawbacks to using such saws, namely that because the sawing action is done by hand, the saw cannot cut very quickly and the person operating the saw can become tires and therefore have difficulty keeping the saw on the correct path. Over time, motorized, handheld saws become the preferred type of saw to cut dental casts and the like. A motorized saw includes a drive mechanism that drives a dental saw blade at a prescribed speed (RPM).

FIG. 1 is side elevational view of a conventional dental saw blade 10 for use in a motorized dental saw. The dental saw blade 10 typically has an annular shape and more specifically, is ring-shaped. The dental saw blade 10 has an opening 20 (e.g., circular opening) formed in an inner section 12 thereof to receive a component (e.g., a hub or drive shaft) of the drive mechanism to effectuate rotation of the dental saw blade 10. The dental saw blade 10 also includes a circumferential outer edge 14 that represents the edge of the dental saw blade 10 that makes contact with and cuts the workpiece.

The dental saw blade 10 has a cutting section (or zone) 30 of a predetermined width that extends around the entire circumference of the dental saw blade 10. The cutting section 30 includes the outer edge 14 and extends inwardly toward the opening 20 and thus has a ring-shape. It will be appreciated that the cutting section 30 is formed on both the first face 16 and the opposing second face 18 of the dental saw blade 10. An intermediate section 40 is formed between the cutting section 30 and the opening 20. Because the cutting section 30 serves as the surface of the blade 10 (besides the outer edge itself) that contacts the dental material during a cutting operation, an abrasive material 50 is disposed within the cutting section 30 to enhance the cutting capabilities of the blade 10.

The dental saw blade 10 is typically formed of a metal material; however, the dental saw blade 10 is quite flexible due to the reduced thickness thereof. More specifically, one type of material to form the dental saw blade 10 is a hardened stainless steel and the blade 10 has a thickness of about 0.003 inch or greater, with a diameter being about 1.5 inch or greater. Any number of abrasive materials 50 can be used with diamond particles being one preferred material due to its physical properties, i.e., hardness.

While the dental saw blade 10 is satisfactory for its intended use, there are a number of disadvantages that are associated with the use of the dental saw blade 10. First, the cutting section 30 only has a width of about ¼ inch and this results in the dentist experiencing difficulties during the cutting operation due to the thickness of the blade 10 itself. More specifically, the thickness of the blade 10 is only about 0.005 inch and therefore, the blade 10 is very flexible and can easily bend during a cutting operation. As a result, when a cut is made into the dental material and the blade 10 is advanced further into the dental material, there is a tendency for the dental saw blade 10 to bind, causing the cut of the dental material to not be straight. Second, when the user needs to make a deep cut, the dental saw blade 10 binds with the dental material when the blade 10 passes the cutting section 30. Since the cuts that are being made are very intricate and have small dimensions, such binding, warping and bending of the blade 10 results in the cut being oversized. This spoils the dental material and the dental saw blade 10 since both will then need to be discarded.

What has heretofore not been available is a dental saw blade that includes stiffening and anti-binding features that overcome the deficiencies associated with conventional dental saw blades.

### SUMMARY

A dental saw blade is provided and includes a body having a first face and an opposing second face and a cutting edge that extends around a perimeter edge of the body. Typically, the body has a circular shape and further has an opening formed in the center thereof for receiving a driving component to cause rotation of the dental saw blade when the saw is actuated.

The blade has a cutting zone formed on each of the first and second faces with the cutting zone extending around a peripheral area of the respective face. The cutting zone has an abrasive material disposed therein and in an exemplary embodiment, the cutting zone is ring shaped with its outer edge being the cutting edge of the blade. One preferred abrasive material is diamond particles.

The blade body also has a plurality of spokes formed on each of the first and second faces. Each spoke is formed of an abrasive material and is arranged radially relative to the cutting zone. More specifically, one end of the spoke intersects the cutting zone so as to form a seamless transition from the cutting zone to the spoke and the other end of the spoke extends inwardly towards but is spaced slightly from the central opening formed in the blade body. The spokes can be formed to have any number of shapes and sizes and preferably, there are more than two spokes formed on each face. The spokes are also preferably formed such that the spokes formed on the first face do not overlie the spokes formed on the second face. In other words, the spokes formed on the second face are formed such that they are disposed in spaces between adjacent spokes formed on the first face.

The spokes on each face are also formed of an abrasive material; however, the abrasive material of the spokes does not have to be the same abrasive material that is used to form the cutting zone. Thus, for ease of manufacturing, the same abrasive material can be used to form the spokes and the cutting zone or a different abrasive material can be used.

The inclusion of spokes provides a number of advantages that permits the present dental saw blade to overcome the disadvantages associated with conventional dental saw blades. First, the spokes act as a means for stiffening the blade body and therefore reduce the likelihood that the blade will warp or otherwise bend during normal cutting operations. Second, the spokes also act as anti-binding features since once the dental blade extends beyond the cutting zone during a deep cut, the material (i.e., dental material) is still cut by the spokes since there is a seamless transition from the cutting zone to the spokes and due to the spokes being formed of an abrasive material. Thus, the dental blade does not bind during deep cuts when the blade extends beyond the cutting zone.

Other features and advantages of the present invention will be apparent from the following detailed description when read in conjunction with the accompanying drawings.

### BRIEF DESCRIPTION OF THE DRAWING FIGURES

The foregoing and other features of the present invention will be more readily apparent from the following detailed description and drawings of illustrative embodiments of the invention in which:

FIG. 1 is a side elevational view of a conventional dental saw blade having an abrasive region extending along an outer circumferential section of the blade;

FIG. 2 is a side elevational view of a dental saw blade according to a first embodiment; and

FIG. 3 is a side elevational view of a partial section of dental saw blade according to a second embodiment.

### DETAILED DESCRIPTION OF PREFERRED EMBODIMENTS

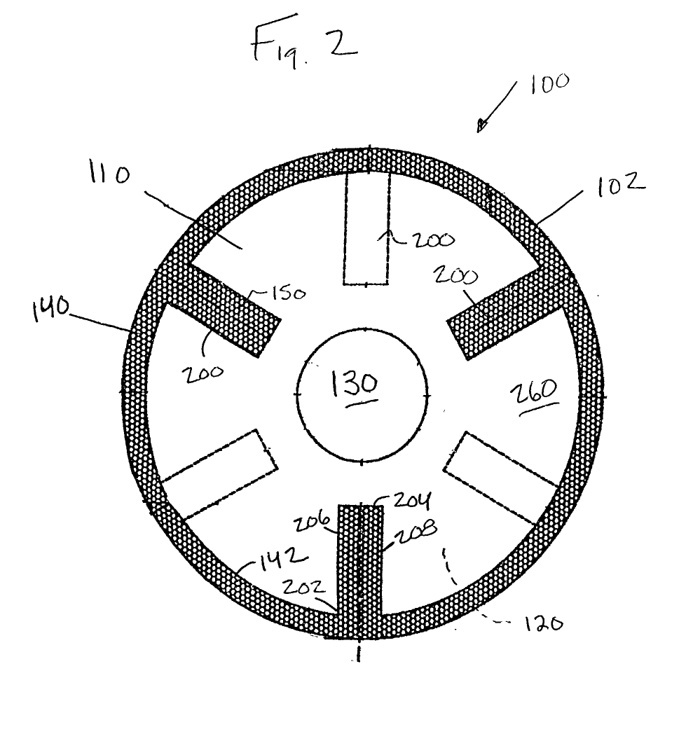

Referring first to FIG. 2 in which an exemplary dental saw blade 100 according to a first embodiment is illustrated. The blade 100 is of an annular construction in that it has a circular shape and includes a circumferential outer edge 102. The blade 100 has a first face 110 and an opposing second face 120 and is formed of any number of materials that are suitable for the intended use, such as a metal. For example, one exemplary metal is hardened stainless steel and another exemplary metal is spring steel that has been hardened, ground and tempered.

The blade 100 has an opening 130 formed in a central portion thereof for receiving a drive component, such as a drive shaft or hub, in a coupling relationship so as to cause rotation of the blade when the drive component is actuated, e.g., when the motorized saw is started. In the illustrated embodiment, the opening 130 has a circular shape which is the most common shape as a result of most drive components also having a circular shape.

In order to enhance the cutting capabilities of the dental saw blade 100, a cutting zone 140 is formed on each of the first face 110 and the second face 120. Preferably, the cutting zone 140 has a ring-like shape in that the cutting zone extends from the outer edge 102 inwardly to an inner edge 142. The inner edge 142 of the cutting zone 140 is thus spaced inwardly from the outer edge 102 and the cutting zone 140 thus has a width that is defined as the distance from the outer edge 102 to the inner edge 142. The width of the cutting zone 140 is preferably uniform around the circumference of the dental saw blade 100 and therefore, the cutting zone 140 has an annular shape.

The cutting zone 140 of the dental saw blade 100 has a material 150 disposed thereon which is different from the material that forms the blade 100 itself. Preferably, the material 150 that is disposed throughout the cutting zone 140 is an abrasive material which forms a cutting surface for cutting the dental material by the blade 100. For example, the material 150 can be any number of abrasive or superabrasive materials that are commercially available including but not limited to diamond, cubic boron nitride (CBN), aluminum oxide, silicon carbide, tungsten carbide grit, boron carbide or other abrasive grit. The size of the abrasive material 150 can vary depending upon the particular application; however, exemplary abrasive materials have grit sizes from about 60 mesh to about 600 mesh. One preferred material 150 is diamond particles that are securely disposed on and held to the blade material defining the cutting zone 140 on both the first and second faces 110, 120. Any number of conventional methods can be used to securely bind the abrasive material 150 to the blade material, including but not limited to impregnating the blade material within these regions during the fabrication of the blade 100. Other fusing/bonding techniques can be used to effectively embed/anchor the abrasive material 150 within the blade material so that a portion of the abrasive material 150 protrudes above the surface of the blade material, thereby creating an abrasive, roughened surface.

The dental saw blade 100 can come in a number of different dimensions depending upon the precise application and in general, the present blade 100 can be formed to have dimensions that are typically found in conventional dental saw blades. For example and according to one exemplary embodiment, the dental saw blade 100 has a diameter from about 1.5 inch to about 7.5 inch and the diameter of the opening 130 is from about ¾ inch to about 1.5 inch. The thickness of the dental saw blade 100 is from about 0.003 inch to about 0.045 inch. The cutting zone 140 has a width of about ⅛ inch to about ½ inch; however, these dimensions can vary depending upon the dimensions of the blade 100 itself.

The dental saw blade 100 includes a plurality of features 200 that increases the robustness of the blade 100 and improves the overall cutting performance and life span of the dental saw blade 100. The plurality of features 200 is in the form of a predetermined number of spokes that are formed radially around the inner opening 130 with each spoke 200 having a first end 202 that intersects the inner edge 142 of the cutting zone 140 and an opposing second end 204 that is closer to and spaced from the inner opening 130. In the illustrated embodiment, each spoke 200 has a generally rectangular shape; however, it will be appreciated that the shape of the spoke 200 is not critical and therefore, the spoke 200 can be formed in any number of different shapes. Because the first end 202 joins the spoke 200 to the cutting zone 140, the first end 202 will not be linear but will be slightly arcuate in shape, while the second end 204 can have a linear construction. The spoke 200 also has side edges 206, 208 that are parallel to one another when the spoke 200 has a rectangular shape.

The spokes 200 are preferably formed on both the first face 110 and the second face 120 in an off set manner, as illustrated in FIG. 2. In other words, none of the spokes 200 formed on the first face 110 overlies one of the spokes 200 formed on the opposite second face 120. The predetermined number of spokes 200 that are formed on each face 110, 120 varies on several factors, including the dimensions of each spoke 200 to be formed and according to the overall dimensions of the blade 100. Preferably, two or more spokes 200 are formed on each of face 110, 120. For example, either 2, 3, 4, 5 or 6 spokes can be formed on each face 110, 120 in an arrangement such that none of the spokes 200 on the first face 110 overlies one of the spokes 200 formed on the second face 120. FIG. 2 illustrates an embodiment where three spokes 200 are formed on each face 110, 120 with the three spokes 200 being evenly spaced apart from one another and arranged so that the three spokes 200 on the first face 110 are disposed in spaces formed between the three spokes 200 formed on the second face 120 if the spokes 200 were translated to the second face 120. In other words and as illustrated in FIG. 2, the spokes 200 are not formed in an overlying relationship.

According to one exemplary embodiment, the width of one spoke 200 is from about ¼ inch to about ¾ inch (depending upon the number of spokes and dimensions of the blade) and a distance from the second end 204 to the outer edge 102 is from about ¾ inch to about 1.5 inch.

The second end 204 of the spoke 200 is spaced slightly away from the opening 130 to permit a flange or other part of the drive component (e.g., drive shaft) to seat against the face of the blade 100 in an area free of spokes 200. It is not desired for the drive component to seat against the abrasive material of the spokes 200 when the blade 100 is disposed on and locked to the drive component.

Preferably, the lengths of each spoke 200 are the same. In the illustrated embodiment, the spokes 200 are arranged so that each spoke 200 on the first face 110 has a complementary spoke 200 on the second face 110 that is about 180° from the spoke 200 formed on the first face 110.

It will be appreciated that cutting zone 140 and the spokes 200 do not necessarily have to be formed of the same material. However, the cutting zone 140 and spokes 200 should both be formed of abrasive materials that can facilitate the cutting action of the blade 100. In other words, two different types of abrasive materials can be used with one being used for the cutting zone 140 and the other being used for the spokes 200. For ease of manufacturing, the material that is used to form the spokes 200 is preferably the same material as the abrasive material 150 that is used to form the cutting zones 140. In other words, the spokes 200 are formed at the same time that the cutting zones 140 are formed.

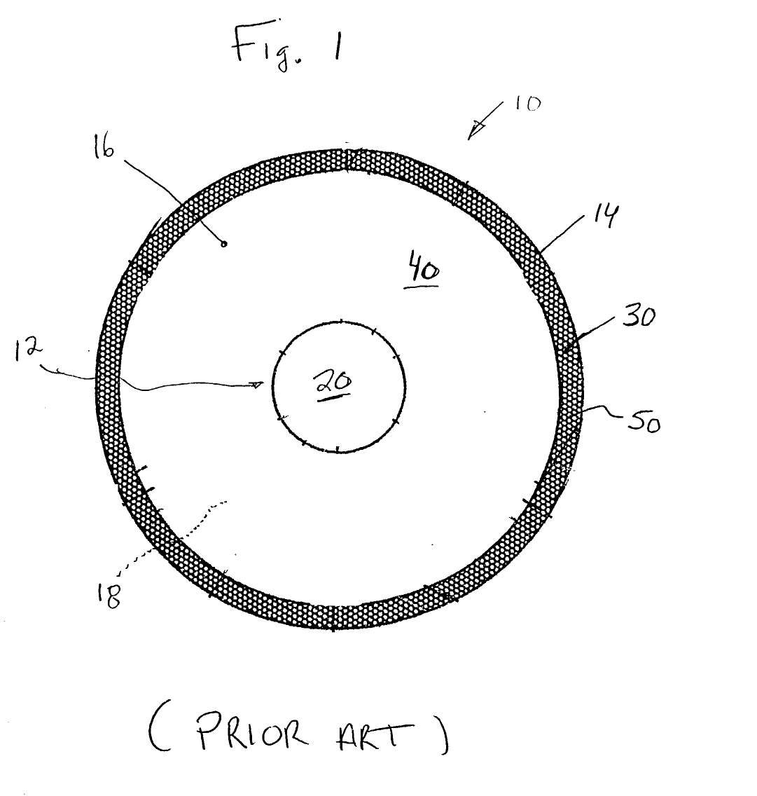

As previously mentioned, several disadvantages of the conventional saw blade 10 of FIG. 1 include that the thinness of the blade 10 causes the blade 10 to be very flexible and therefore easily bends during normal cutting operations. In addition, when it is necessary for the dental saw to make a deep cut, the dental saw blade 10 can easily bind with the dental material when the blade 10 passes the cutting zone 30. The bending and binding actions cause the blade 10 to warp which results in the cuts being oversized and requires the cut dental material and the blade 10 itself to have to be rejected.

The present Applicant has discovered that by adding the spokes 200 to each of the faces 110, 120, the stiffness of the blade 100 is advantageously increased since the spokes 200 serve to increase the robustness of the blade 100 due to the spokes 200 acting as structural enhancing features. By arranging the spokes 200 on the two faces 110, 120 such that the spokes 200 do not overlie one another, the stiffness of the entire blade 100 is increased since most regions of the blade 100 have a spoke 200 formed thereon, whether the spoke 200 is formed on the first face 110 or on the second face 120. Because the stiffness of the blade 100 is increased as a result of the formation of the spokes 200, the flexibility of the blade 100 is decreased and accordingly, the blade 100 does not excessively bend during normal cutting actions. As a result, the blade 100 maintains a cut that has a width that is equal to the thickness of the blade 100. In other words, the cut is not oversized due to warping of the blade as is the case with conventional blades.

Moreover, the blade 100 also provides a dental saw blade that can make a deep cut beyond the boundary of the cutting zone 140 without the blade 100 binding with the dental material due to the spokes 200 being formed of an abrasive material (just as the cutting zone 140). Once the blade 100 advances beyond the cutting zone 140 during a cutting action, the blade 100 can continue to cut without binding because the spokes 200 selectively contact the dental material as the blade 100 rotates. Thus, the dental material remains in contact with an abrasive material that can facilitate cutting of the dental material. The blade 100 can therefore continue to cut the dental material as it is advanced into the dental material so long as the dental material is in contact with either the cutting zone 140 or the spokes 200.

The arrangement of the spokes 200 creates spaces 260 on each face between the spokes 200 which are free of any abrasive material and therefore have a slightly reduced thickness. During the cutting of the dental material, the cutting action produces dust particles which tend to deposit on the faces of the blade 100. By forming spaces 260, an area is provided for the dust particles to accumulate instead of the cutting surfaces themselves (i.e., the cutting zone and the spokes). By getting the dust particles away from the cutting surfaces, it is less likely that binding of the blade will result. More specifically, one of the reasons that binding of the blade 100 occurs is due to a build-up of dust particles on the cutting surfaces. By providing a non-cutting surface area for the dust particles to accumulate, the blade 100 further reduces the chance that binding will occur during normal cutting applications.

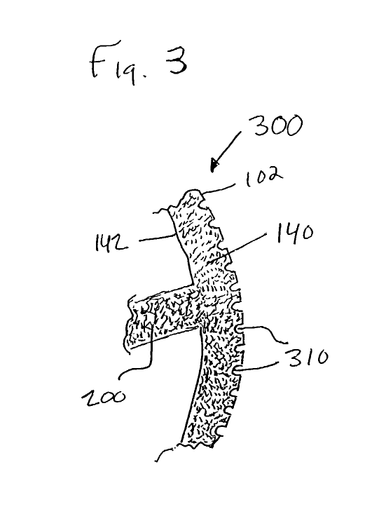

FIG. 3 illustrates a partial section of a blade 300 according to another embodiment. Blade 300 is very similar to the blade 100 in that the blade 300 includes cutting zone 140 and spokes 300 formed radially around each of the blade faces 110, 120. The only difference between the blade 300 and the blade 100 is that the cutting zone 140 in this embodiment has a number of slots 310 formed circumferentially around the outer edge 102. The number, shapes and dimensions of the slots 310 vary depending upon on a number of factors, including design choice. In the illustrated embodiment, each slot 310 has a U-shape with the open end being formed along the outer edge 102 and the inner arcuate portion of the slot 310 being spaced inwardly from the outer edge 102 but still within the cutting zone 140. Between the U-shaped slots 310, the outer edge 102 defines an arcuate edge that comprises a cutting edge when the blade 300 contacts the dental material.

As previously-mentioned, when the saw is used to cut a workpiece (i.e., dental material), it produces dust particles which tend to deposit on the faces of the blade. However, with slots 310 being formed in the cutting zone 140 and more particularly, at the cutting edge, any dust generated during cutting tends to concentrate in the slots 310 (e.g., on a trailing edge of the slot 310) rather than on the faces of the blade 300, thereby keeping the effective thickness of the blade thin and accordingly keeping the cut thin as it is supposed to be, as opposed to an oversized cut being formed due to excessive build-up.

The following example is provided to be illustrative of the present blade and is not to be construed as being limiting.

### EXAMPLE

A dental saw blade in the form of the blade 100 illustrated in FIG. 2 was produced and used repeatedly in typical dental applications to cut dental materials. The dental saw blade 100 was used over 400 times and did not show signs of excessive wear and importantly, the blade 100 did not bind and warp during deep cuts. In contrast, the conventional device 10 excessively warped and binded during the same applications and after 30 or so cutting applications, the blade 10 had to be discarded.

It is preferred that the spokes 200 have ends that intimately join the cutting zone 140 to form a continuous, uninterrupted transition between the two because as the user makes a deep cut and extends beyond the cutting zone 140, the spokes 200 act as cutting surfaces and therefore, the transition should be seamless so as to create a nice smooth cutting action. This also reduces the chances that binding or warping will occur.

While the invention has been particularly shown and described with reference to preferred embodiments thereof, it will be understood by those skilled in the art that various changes in form and details can be made therein without departing from the spirit and scope of the invention.

What is claimed is:

1. A dental saw blade comprising:
a body having a first face and an opposing second face and a cutting edge;
a cutting zone formed on each of the first and second faces and extending around a peripheral area of each of the first and second faces, the cutting zone having an abrasive material disposed therein; and
a plurality of spokes formed on each of the first and second faces, each spoke being formed of an abrasive material and arranged radially relative to the cutting zone.

2. The blade of claim 1, wherein the body includes an opening formed therethrough for receiving a drive component for rotating the blade, the plurality of spokes being arranged radially around the opening.

3. The blade of claim 1, wherein the cutting zone extends inwardly from the cutting edge to a point closer to the center of the blade, the cutting zone having a width from about ⅛ inch to about ½ inch, where the width is defined as distance from the cutting edge to the inner point

4. The blade of claim 1, wherein the blade has an annular shape and the cutting zone is ring-shaped.

5. The blade of claim 1, wherein each of the plurality of spokes has a uniform width.

6. The blade of claim 1, wherein the abrasive material of the plurality of spokes and the cutting zone is the same material.

7. The blade of claim 1, wherein the abrasive material of the plurality of spokes and the cutting zone is different.

8. The blade of claim 1, wherein each spoke joins the cutting zone at one end thereof such that the abrasive material extends seamlessly from the cutting zone to each spoke.

9. The blade of claim 1, wherein the abrasive material is a material selected from the group consisting essentially of diamond, cubic boron nitride (CBN), aluminum oxide, silicon carbide, tungsten carbide grit, and boron carbide.

10. The blade of claim 1, wherein the abrasive material comprises diamond particles having a size from about 60 mesh to about 600 mesh.

11. The blade of claim 1, wherein the plurality of spokes contained within a first plane defined by the first face are offset from the plurality of spokes contained within a second plane defined by the second face such that no one spoke of the first plane overlies a spoke contained within the second plane.

12. The blade of claim 1, wherein three or more spokes are formed on each of the first and second faces.

13. The blade of claim 1, wherein each spoke formed on the first face has a complementary spoke formed on the second face that is offset 180° from the spoke formed on the first face.

14. A dental saw blade comprising:
a body having a first face and an opposing second face and a cutting edge and a central opening for receiving a drive component for rotating the blade;
a region of abrasive material disposed on each of the first and second faces to define a cutting zone at an outer section of the face; and
means for stiffening the body and reducing binding of the blade during a cutting operation, wherein the means is disposed between the cutting zone and the central opening and includes features that are formed on each of the first and second faces.

15. The blade of claim 14, wherein the features comprise a plurality of spokes formed on each of the first and second faces, each spoke being formed of an abrasive material.

16. The blade of claim 15, wherein one end of each spoke intersects the cutting zone and a seamless transition results between the cutting zone and the plurality of spokes formed on the same face.

17. The blade of claim 14, wherein the cutting zone is ring shaped and extends inwardly from the cutting edge.

18. The blade of claim 14, wherein the abrasive material is a material selected from the group consisting essentially of diamond, cubic boron nitride (CBN), aluminum oxide, silicon carbide, tungsten carbide grit, and boron carbide.

19. The blade of claim 14, wherein the abrasive material comprises diamond particles having a size from about 60 mesh to about 600 mesh.

20. The blade of claim 15, wherein the plurality of spokes contained within a first plane defined by the first face are offset from the plurality of spokes contained within a second plane defined by the second face such that no one spoke of the first plane overlies a spoke contained within the second plane.

21. The blade of claim 15, wherein three or more spokes are formed on each of the first and second faces.

22. The blade of claim 14, further including a plurality of shaped cut-outs formed in the cutting zone at the cutting edge thereof, the shaped cut-outs being formed circumferentially around the blade body along the cutting edge thereof.

23. The blade of claim 15, wherein an inner edge of each spoke is spaced from the central opening.

24. The blade of claim 15, wherein the spokes formed of each face are spaced equally apart from one another.

25. The blade of claim 15, wherein a length of each spoke is at least twice as great as a width of the cutting zone.

26. The blade of claim 14, wherein the features are shaped spokes formed of abrasive material.

27. The blade of claim 26, wherein the cutting zone has a thickness that is the same as a thickness of the spokes.
